(19) United States
(12) Patent Application Publication
(10) Pub. No.: US 2011/0138714 A1
(43) Pub. Date: Jun. 16, 2011

(54) EXTERIOR STAINABLE VINYL DOOR OR WINDOW SYSTEM

(76) Inventor: Gerald Harry Van Seters, Coaldale (CA)

(21) Appl. No.: 12/635,918

(22) Filed: Dec. 11, 2009

(51) Int. Cl. E06B 3/30; E04B 1/66; E04C 2/20; B44F 9/02; E06B 3/00

(52) U.S. Cl. 52/204.5; 52/515; 52/309.1; 52/313; 52/745.15; 52/745.19

(57) ABSTRACT

The present invention is method and product for a door system or window system incorporating stainable vinyl components. The stainable vinyl may be result in a finish that is similar to that of stained wood. The effect may be that the stained vinyl has the same look as any stained wood component of a door system or window system to achieve an aesthetically pleasing effect.

### FIELD OF INVENTION

This invention relates in general to the field of a stainable indoor and outdoor surface covering and more specifically to an exterior stainable vinyl door or window system for a door or window and a method for making same.

### BACKGROUND OF THE INVENTION

Door and window frames were traditional formed of wood or other natural fibers. These types of frames were found to be susceptible to aging and deterioration due to exposure to the outdoor elements and weather. Such aging or deterioration can affect the function of a door and/or window frame. As an alternative to wood other materials have been incorporated into door and window systems, such as steel, aluminum, vinyl, fiberglass, or plastic. Such materials are utilized in particular for outdoor door or window frames due to their ability to withstand the effects of weather.

An effect of utilizing non-wood materials to create a stained wood or fiberglass door slab, shutter or adjacent trim or window frame is that the frame may not match any stained wood door or shutter that is included in a structure. The wood door or shutter may be stained using a staining product. Prior art non-wood materials for door frames and window frames cannot match the appearance of the door or shutter. The result is a lack of a door system or a window system that can be stained to achieve a virtually consistent stained appearance.

Several attempts have been made to produce door or window frames that may have the appearance of wood doors or shutters. U.S. Pat. No. 5,941,033 discloses a vinyl window finish trim assembly which can be fitted with a window frame mounted in a window opening whereby it snaps into attachment with the window frame. When installed no nails or screws are visible. The assembly can have the appearance of painted wood.

U.S. Patent Application No. 2004/0200547 discloses a method for producing components that are wrapped or laminated. A thin veneer, foil, paper, metal, plastic, composite, or other material is applied to the outside of the product. The component therefore does not have an appearance of the material that the component is produced from, but rather of the thin veneer. In particular the method ensures that components formed from dissimilar materials may have the appearance of a solid or continuous component.

U.S. Patent Application No. 2008/0026157 discloses a method for coating metallic surfaces with paint or a paint-like coating prior to forming any object from the coated metallic materials. U.S. Patent Application No. 2008/0241457 discloses a method of causing an interior trim component to take on the appearance of a different material. In this patent the component includes an aerated skin layer and a glass-reinforced urethane substrate layer. For example, the component may include a texture/grain characteristic.

### SUMMARY OF THE INVENTION

In one aspect, the present disclosure relates to a stainable vinyl door or window system for in situ installation including a wood substrate and a vinyl covering system adapted to accept a stain colour matching system. The vinyl covering system includes a top layer with a printed wood grain pattern and a bottom layer adapted to adhere to the wood substrate. The stain colour matching system may be applied to the top layer of the vinyl covering system after the installation of the door system. The wood substrate may preferably be wood or poly vinyl chloride (PVC).

In another aspect of the present invention a stainable vinyl door system is disclosed for installation into an environment and includes a wood substrate, and a vinyl covering system adapted to accept a stain colour matching system. The vinyl covering system may have a top layer with a printed wood grain pattern and a bottom layer adapted to adhere to the wood substrate so that the stain colour matching system matches the stainable vinyl door system identically to the environment.

In another aspect of the instant invention there is provided a method of assembling a stainable vinyl door or window system which includes covering a wood substrate with a vinyl covering system adapted to accept a stain colour matching system, adhering a bottom layer of the vinyl covering system to the wood substrate, adhering a top layer of the vinyl covering system with a printed wood grain pattern to the bottom layer, installing the stainable vinyl door system, and applying the stain colour matching system to the top layer of the vinyl covering system after the installation of the door system.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1a is a side section view of a profile product.

FIG. 1b is a perspective view of a profile product.

FIG. 2a is a side section view of a profile product.

FIG. 2b is a perspective view of a profile product.

FIG. 3a is a side section view of a profile product.

FIG. 3b is a perspective view of a profile product.

FIG. 4 is a perspective view of a finger jointed product.

FIG. 5 is an exploded view of a single door system.

FIG. 6 is an exploded view of sidelite and transom options.

FIG. 7 is an exploded view of brickmold components.

FIG. 8 is an exploded view of door jamb components.

FIG. 9 is an exploded view of sidelite components.

FIG. 10 is an exploded view of transom box components.

FIG. 11 is an exploded view of a first embodiment of the arch transom.

FIG. 12 is an exploded view of a second embodiment of the arch transom.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is method and product for a door system or window system incorporating stainable vinyl components. The stainable vinyl may result in a finish that is similar to that of stained wood. The effect may be that the stained vinyl has the same look as any stained wood component of a door system or window system to achieve an aesthetically pleasing effect.

Furthermore the stainable vinyl door or window system for in situ installation including a wood substrate and a vinyl covering system adapted to accept a stain colour matching system. The vinyl covering system includes a top layer with a printed wood grain pattern and a bottom layer adapted to adhere to the wood substrate. The stain colour matching system may be applied to the top layer of the vinyl covering system after the installation of the door system. The stain colour matching system may be further comprises a desired stain colour applied to the stainable vinyl door system once the stainable vinyl door system is in situ and a transparent protective layer applied on top of the desired stain colour such as urethane.

The door system or window system of the present invention may comprise components either formed of stainable vinyl or having stainable vinyl moulded or otherwise attached thereto. The vinyl may be stained, painted, otherwise coloured or coated, or any combination of these. For example, it may be possible to stain the vinyl with a stain to achieve a finish similar to that of stained wood. Therefore, the vinyl may be stained to appear to have the same finish as a wooden article positioned near the vinyl, such as a door or shutter. In this manner all of the stained vinyl components of a door system and/or window system may match or be otherwise coordinated. The stained vinyl may further match one or more other stained articles positioned near the door system or window system of the present invention. When the door system and/or window system is installed the effect may be a consistent stained appearance.

The stainable vinyl may be formed of a variety of vinyl materials, for example, such as polyvinyl chloride. It may incorporate multiple layers, such as two layers. For example, the vinyl may be double layered vinyl having a base layer of approximately 100+−20 μm and a top layer of approximately 50+−20 μm. A skilled reader will recognize that a variety of vinyl materials may be utilized for the present invention. The exterior surface of the vinyl of the present invention may be moulded or otherwise shaped to incorporate grains. Such grains may be similar in shape and format to the grain found in natural wood.

The stainable vinyl may be attached to one or more components of a door system or window system. Such components may be formed of a variety of materials including lightweight materials and low cost materials, such as low grade wood materials. For example, in one embodiment of the present invention vinyl may be attached to components formed from vinyl substrate, pine or plywood.

The present invention may offer particular benefits over the prior art. Prior art examples provide a means of snapping a component that is pre-coloured or has a wood-grain look over a window frame. The present invention permits the vinyl to be stained: prior to installation of the door system or window system; after the door system or window system is installed; or at a combination points of prior to and post-installation. The capability to stain a window system or door system on site after it is installed has the effect that it is not necessary to either: pick a pre-manufactured material that is similar in colour and texture to the stain used on objects, such as a door, shutter or other object; or to stain an object, such as a door, shutter or other object, a colour that is similar to a pre-coloured or pre-stained trim component of a door system or window system.

The present invention may allow the vinyl to be stained utilizing the same stain that is used on an object, such as a door or shutter created from wood or other material resembling wood. Consequently, the object and stainable vinyl may match in colour and appearance in an aesthetically pleasing manner.

The present invention may offer a further benefit over the prior art. The prior art examples are limited in application. Only portions of entry systems or windows systems, or specific types of entry systems or window systems are included in the prior art. The present invention is applicable to the full spectrum of entry systems and window systems. For example, the present invention may include window frame components as well as transom components to create a window system. These components may include stainable vinyl components.

The present invention may offer yet another benefit over the prior art, namely environmental benefits. Components of door systems and/or window systems of stainable vinyl may be more durable than components formed of other materials. The durability of the stainable vinyl components may cause the door systems and/or window systems to last longer and therefore require replacement at a later period than components of traditional prior art door system and/or window systems.

Additionally, the stainable vinyl components may not require maintenance as often as traditional components. For example, staining or painting may occur less frequently. This can offer an environmental advantage because stain and/or paint is a hazardous material and an environment may be exposed to such materials less frequently fewer hazardous materials will be required to be disposed of in landfills. Additionally, less frequent maintenance may provide a cost benefit.

Additional benefits of the present invention may be that the door system or window system of the present invention may be lightweight and/or low cost. The materials utilized to create the components to which the vinyl is attached may be created of light weight materials. Also the components may be formed from a low grade material, which may also be of a low cost.

The stainable vinyl of the present invention may be moulded to form components or attached to components of varying sizes, heights and widths. The stainable vinyl may be coloured or stained to a variety of colour shades. In one embodiment a combination of paint and stain, or multiple paints and/or stains may be applied to one or more stainable vinyl components. Printing stain may also be applied to one or more stainable vinyl components.

The stainable vinyl may be molded to form one or more components or attached one or more components to create a variety of interior or exterior components of a variety of sizes and thicknesses, including: door systems, incorporating doors having either an inswing or an outswing direction; window systems, having any configuration or combination; transom sizes; PVC transom sizes or shapes; door lite frame styles or sizes; door lite selections; or fixed or venting side lites. The stainable vinyl components may or may not include a door cut out.

In one embodiment of the present invention, the stainable vinyl components and other components of a door system or window system may be attachable to other components by way of any attachment means. For example, such attachment means may include staples, screws, nails, adhesives, as well as other fasteners. Additionally, a variety of hardware may be utilized with the stainable vinyl components and other components of a door system or window system. For example; the hardware utilized may include hinges, a passage strike, a deadbolt strike, a passage lock, a deadbolt, a door, a side panel stop, a side panel, sweep screws or stainable door lite frame inside and out. A skilled reader will recognize that other attachment means and hardware may be utilized with the components of the present invention including any stainable vinyl components.

Stained vinyl components of the present invention may have certain properties. Such stained vinyl components may be resistant to chemicals, for example, such as HCl, Ca(OH)₂, H₂SO₄, NaOH, and Kerosene. Such stained vinyl components may also be resistant to solvents, for example, such as Toluene, Ethyl Acetate, Acetone, and Xylene. Such stained vinyl components may further be abrasion resistant, humidity resistant and scratch resistant.

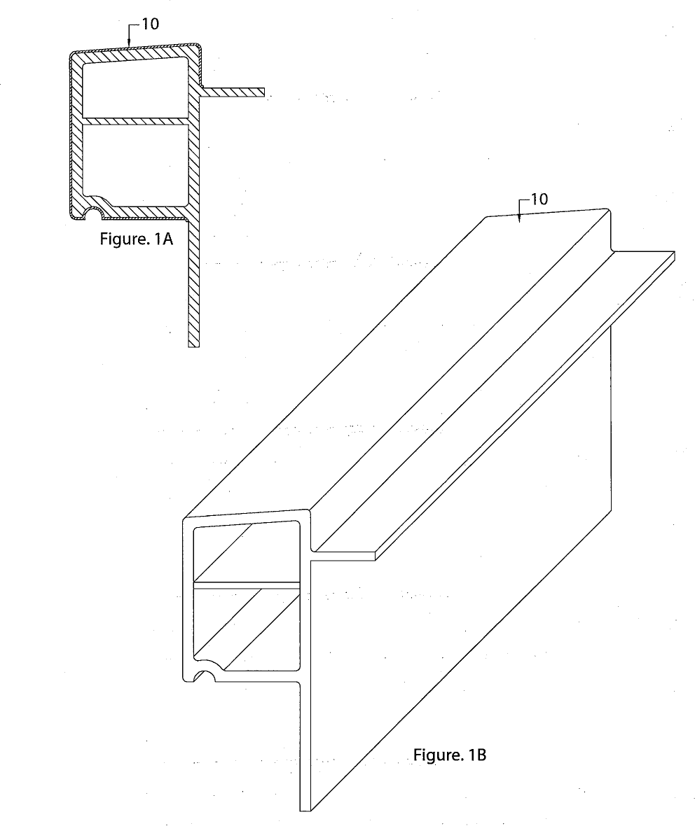

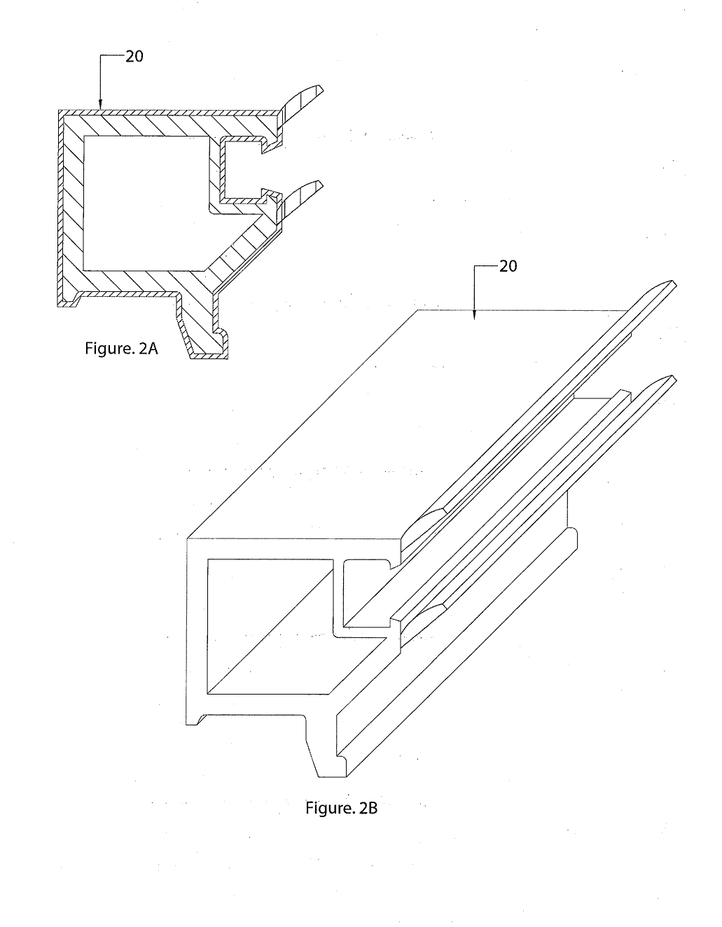

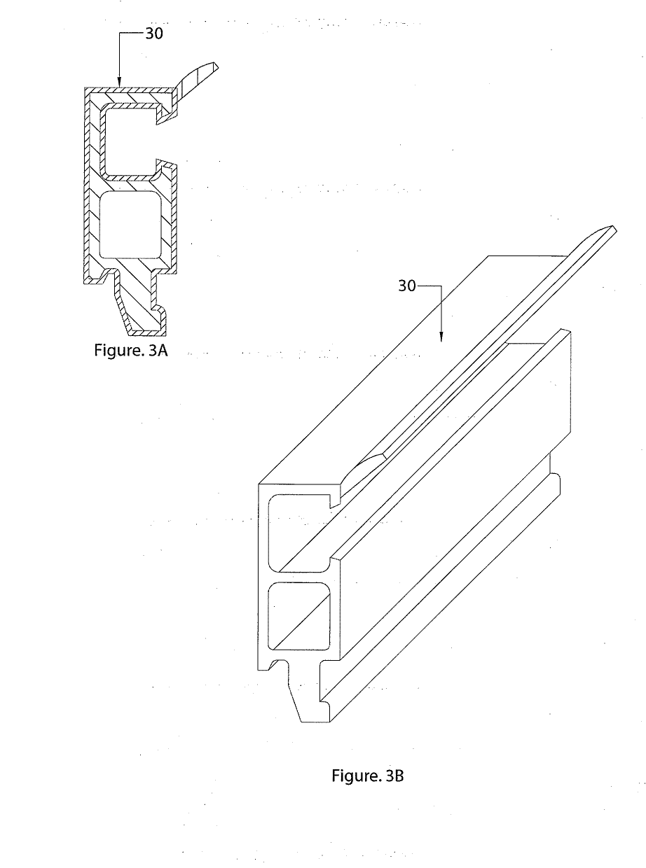

The door system and window system of the present invention may incorporate several components. These components may be of many types and may be used to form elements of a door system or window system, for example, such as a door jamb or brickmold. The components may have a particular shape and/or size. This shape and/or size may facilitate particular connections or attachments between components. For example, profiles pieces may be utilized to form some components of the present invention. Profile pieces may be of various types, for example, such as the profiles pieces 10, 20 and/or 30 as shown in FIGS. 1a, 1b, 2a, 2b, 3a and 3b. The profile pieces may be formed of a variety of materials, including polyvinyl chloride.

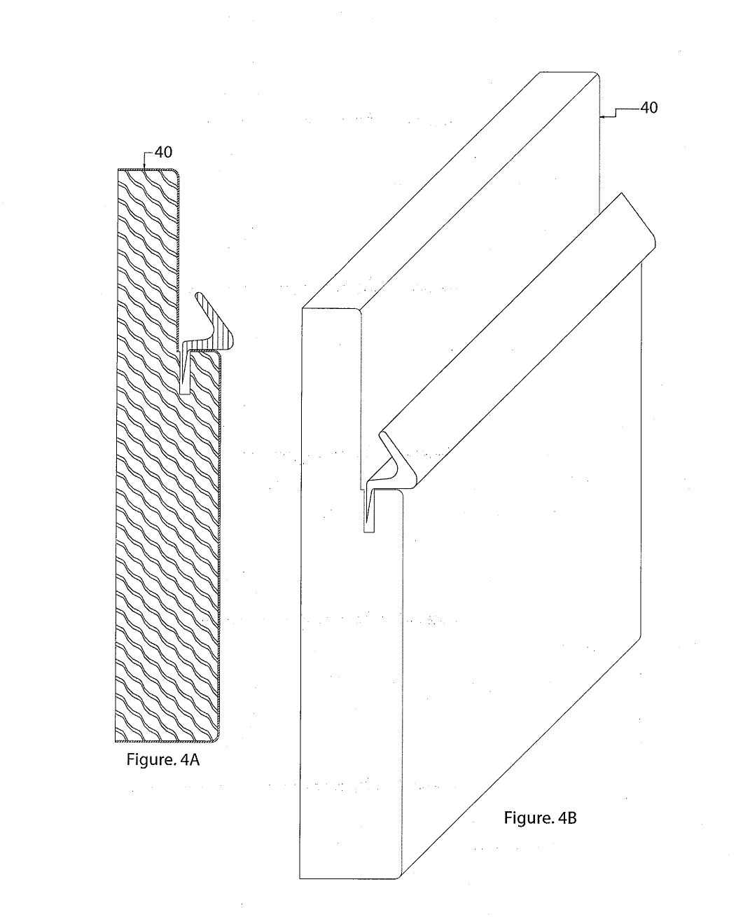

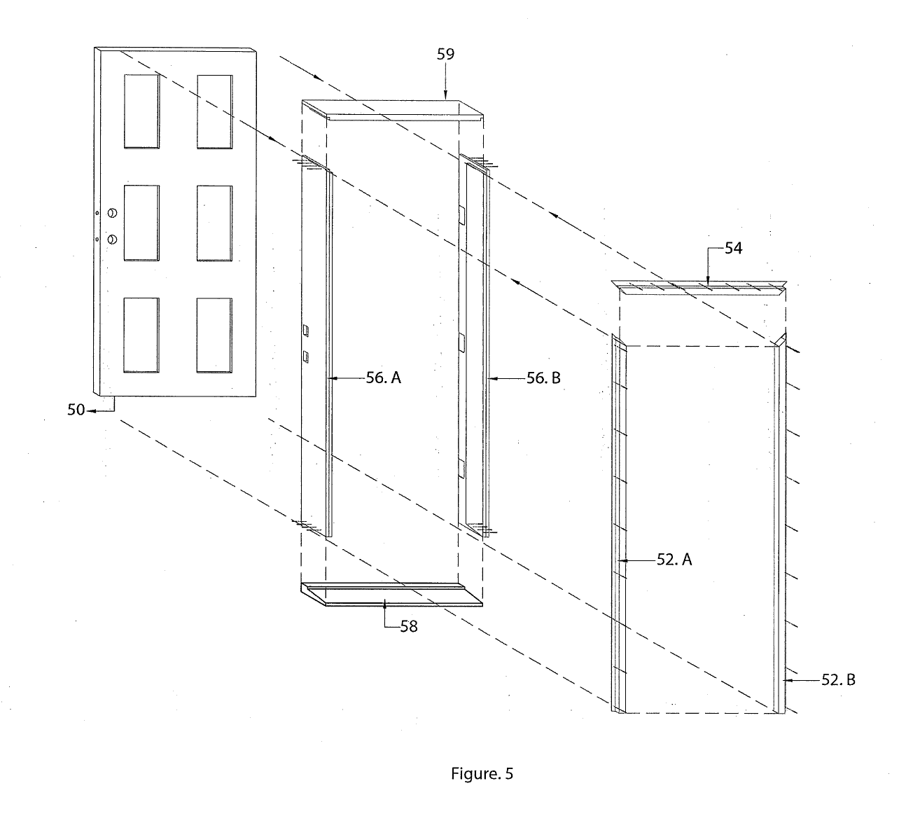

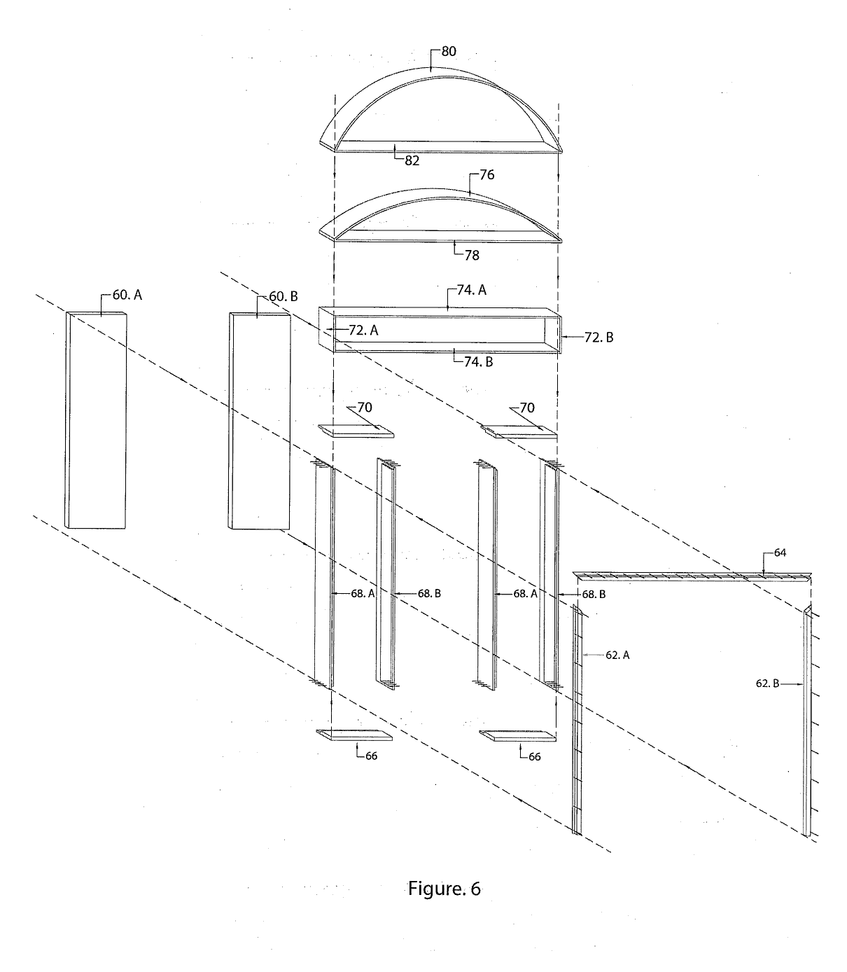

Finger jointed products may also be utilized, for example, such as finger jointed pine wood products. The finger jointed products may be of several forms, for example, such as the finger jointed product 40 shown in FIG. 4. Sill products may also be utilized in the present invention. A skilled reader will recognize that the components of the present invention may vary, but may generally be collectively capable of forming a window system or door system. The assembly of the window system or door system may be of various configurations, for example, such as the configuration shown in FIGS. 5 and 6.

Prior to assembly, vinyl may be prepared for attachment to components of the window system or door system of the present invention. Such components may be formed of lightweight materials, such as pine or vinyl substrate. Moreover, such components may be formed of low cost materials, such as low grade wood, particle board or vinyl substrate. Vinyl may be attached to any component of the present invention, but may particularly be attached to any component that will be visible once the door system or window system is assembled.

Preparing the stainable vinyl for attachment to components of the present invention may involve specific steps, for example, such as slicing the vinyl into strips. The chosen method of attaching the stainable vinyl to the component may also involve specific steps. For example, vinyl may be laminated to components, such as any components formed from finger jointed products. The lamination process may involve a heated adhesive, such as a glue, being applied to the vinyl. The vinyl having a glue coating may be pressed and/or roll-regulated to a component of the present invention, such as wood or vinyl substrate. The ends of the components having stainable vinyl attached thereto may be trimmed. Generally, this step may be taken to ensure that the component and the vinyl adhered thereto have a common endpoint. A skilled reader will recognize that other means of attaching vinyl to one or more components of the window system or door system of the present invention may be utilized. A skilled reader will further recognize that such attachment means may result in a fixed or un-fixed attachment of the vinyl to a component.

The components of the present invention may undergo pre-attachment steps. For example, one or more components may be machined as appropriate so that hardware may be attached to the components as required for the window system or door system. A skilled reader will recognize that a variety of hardware may be utilized in the present invention and that specific machining may be necessary for each hardware piece. Other pre-attachment steps may also occur, such as cutting of components to size, and/or welding of mitered corners. A skilled reader will recognize that the pre-attachment steps may vary in accordance with the components and the configuration of the door system or window system.

In one embodiment of the present invention one or more sustainable vinyl components of the present invention may be stained prior to assembly. Generally, staining may involve one or more coats of a stain product being applied to either components of the present invention having stainable vinyl attached thereto, components of the present invention that are formed of stainable vinyl, and or any other components. A coating, for example, such as urethane or varnish, may also be applied to the stained components.

The components of the present invention may be assembled to form a window system or door system of the present invention. The assembly step may be performed by the customer on-site, or may be performed prior to delivery of a door system or window system to a customer. The exact steps of assembly may vary in accordance with the configuration of the components of the present invention. For example, in one embodiment assembly, as shown in FIGS. 5 and 6, may involve attaching multiple components to form a door system that may include elements, such as a door jamb and a door, as well as other necessary elements to create a door system. The door may be of many types, for example, such as a slab door.

The components may include framing components, as well as other materials, for example, such as weather-stripping. The components may be attached by way of a variety of attachment means, including staples, screws, nails, adhesives, or any other suitable attachment means. The hardware may be attached to components in accordance with the prior machining undertaken to facilitate the attachment of hardware to components of the door system or window system.

In one embodiment of the present invention one or more components of the present invention may be stained following assembly. Generally, staining may involve one or more coats of a stain product being applied to the vinyl attached to components of the present invention and any other components of the present invention that are formed of vinyl. A coating, for example, such as urethane or varnish, may also be applied to the stained components.

The following provides two examples of door systems of the present invention. These descriptions are provided solely as examples. A skilled reader will recognize that other embodiments of the present invention may be possible.

### Single Door System Example

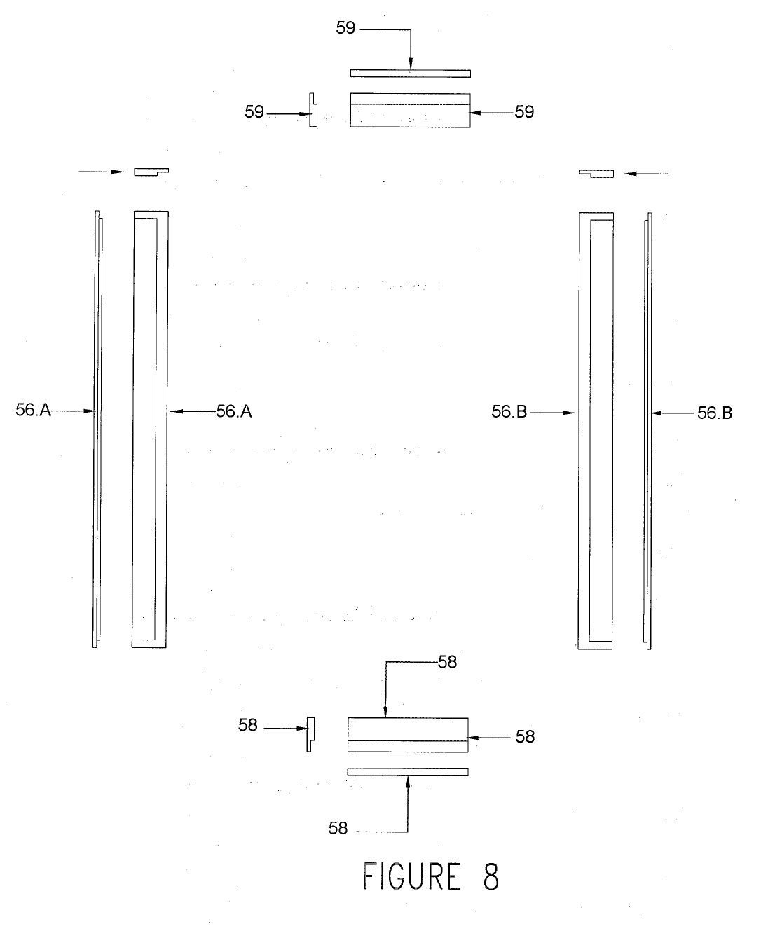

In one embodiment of the present invention, the door system may be a single door system, as shown in FIG. 5. The elements of the door system may include an outer door frame, such as a brickmold, a door and a door jamb. Each of these elements may incorporate one or more components. For example, the door jamb may incorporate one or more vertical panels 56a and 56b and a top panel 59, as shown in FIG. 8. These door jamb components may be attached in a manner whereby a door 50 may be fit within the assembled door jamb, as shown in FIG. 5. The door jamb may further be attached to a sill 58 at the lower portion. The sill may be sloped. Additionally, one or more of the vertical panels may be machined as described above for the purpose of facilitating the attachment of hardware, such as hinges that may be utilized to attach the door to the door jamb. The door may also be machined to facilitate the attachment of at least one door handle and/or one or more locking means. A skilled reader will recognize that a wide variety of components and configurations may be possible for each element of the door system.

To assemble the components of the present invention, a variety of attachment means may be utilized, such as screws. Attachment of the components by way of one or more attachment means may be positioned at a variety of points in the door system, for example, such as at the corner points.

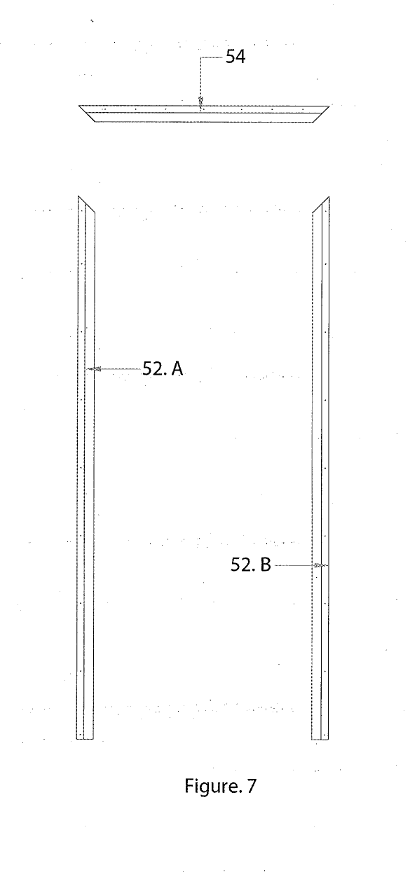

The door jamb may be assembled first, as shown in FIG. 5. Weather-stripping may be inserted into the door jamb to facilitate a seal between the door and the door jamb. A brickmold, incorporating brickmold side panels 52a and 52b and a brickmold top panel 54, as shown in FIG. 7, may be attached to the assembled door jamb, as shown in FIG. 5. Such attachment may be facilitated by either staples or screws. The brickmold may be back-beaded with a sealant, for example, such as Mulco™.

Hardware, such as hinges and locks, may be installed on the door jamb and the door. The installation may be undertaken to correspond with any machined areas in the door jamb and/or door created to facilitate the attachment of hardware thereto. The door may be attached to the door jamb by way of the hardware or by any other means.

In one embodiment of the present invention, the components of the door system may be stained prior to assembly, whereas in another embodiment of the present invention the components of the door system may be stained after assembly. Stain may be applied to stainable vinyl components, other wood components and any other stainable component of the present invention. The components may all be stained the same shade or colour, whereby the door may be stained the same shade or colour as the components of the door jamb and/or brickmold. Alternatively, the components may be stained different shades or colours and these may be complimentary. Generally the overall appearance of the door system may be aesthetically pleasing. A skilled reader will recognize the components may also be painted or coloured by another rmethod.

The choice of one or more stains applied to components of the door system may further reflect compatibility and/or coordination with other objects within the vicinity of the door system once it is assembled and installed. For example, pillars on the front of a building, window systems, furniture, or other objects. In this manner the stained door system may be aesthetically pleasing not only as regards its collective components, but as regards objects near its vicinity.

### Sidelite and Transom Options Example

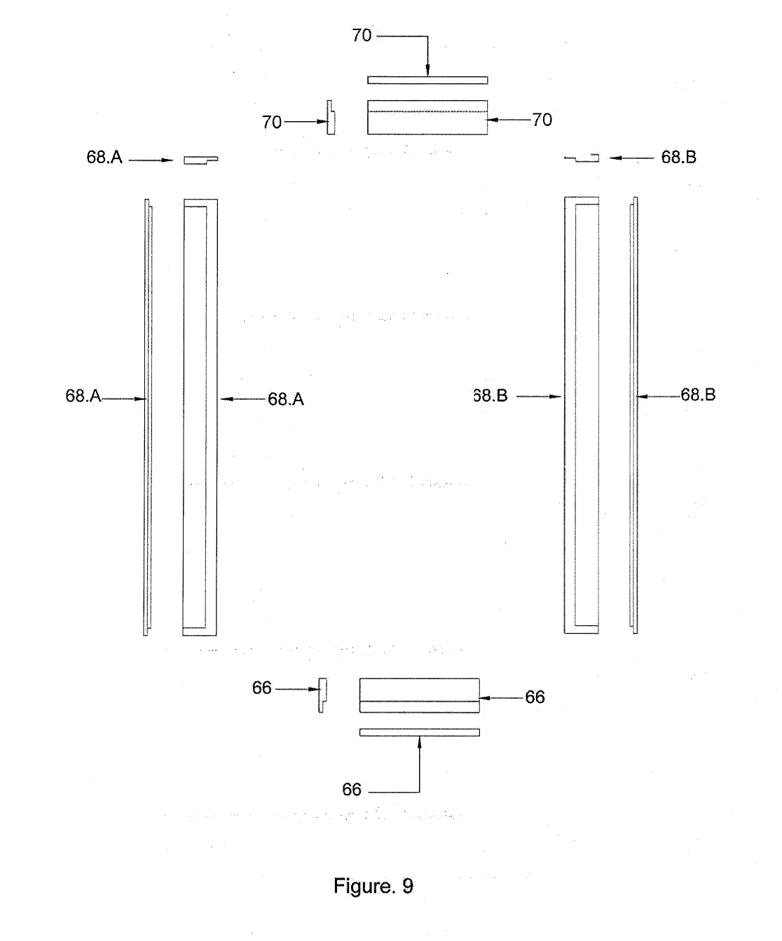

In another embodiment of the present invention, the door system may be a sidelite and transom system, as shown in FIG. 6. The elements of the system may include an outer door frame, such as one or more sidelites, at least one door slab, a transom box and an outer frame, such as a brickmold. Each of these elements may incorporate one or more components. For example, a sidelite, as shown in FIG. 9, may incorporate one or more vertical panels 68a and 68b, a top panel 70 and a bottom panel 66, or sill. These components may be attached in a manner whereby one or more of doors 60a and 60b may be fit within the assembled sidelite, as shown in FIG. 6. Additionally, one or more of the vertical panels may be machined as described above for the purpose of facilitating the attachment of hardware, such as hinges that will be utilized to attach a door to a sidelite. One sidelite may be assembled for each door. The doors may also be machined to facilitate the attachment of at least one door handle and/or one or more locking means. A skilled reader will recognize that a wide variety of components and configurations may be possible for each element of the door system.

A brickmold may be assembled including components, such as, as shown in FIG. 6, one or more vertical brickmold panels 62a and 62b and a top brickmold panel 64. When assembled the top brickmold panel may position the vertical brickmold panels at a distance from one another. This distance may be sufficient for at least the sidelites to fit within the brickmold.

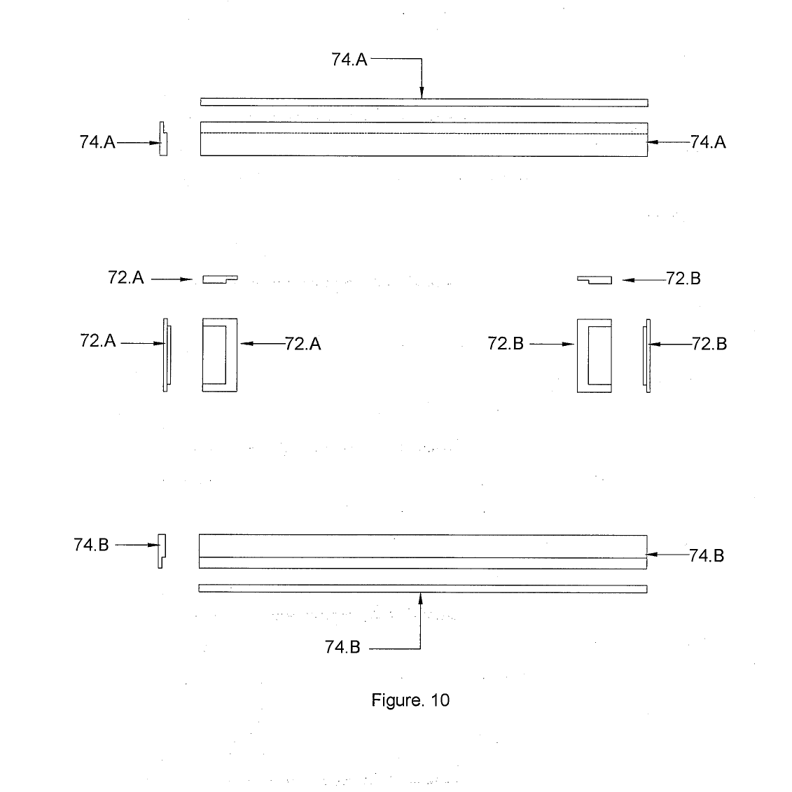

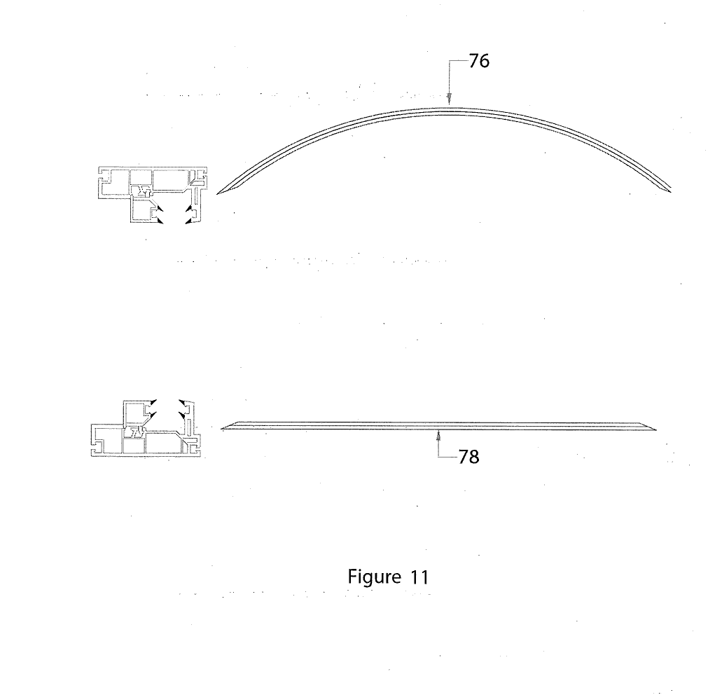

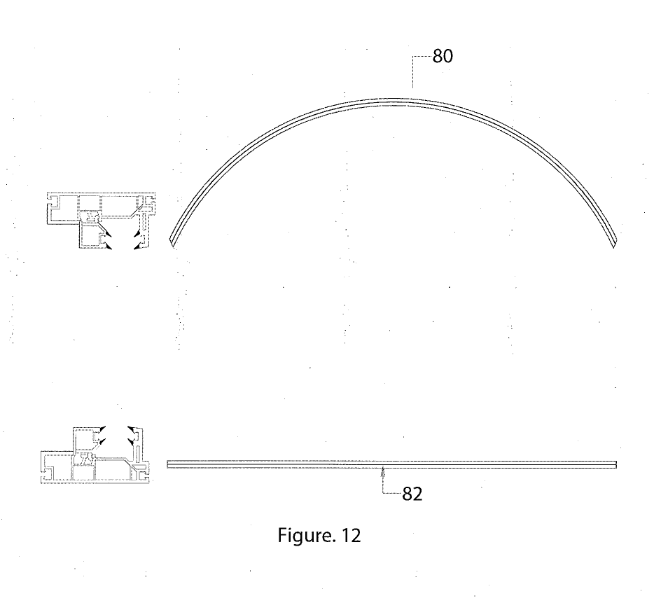

A transom box may be formed of one or more transom side panels 72a and 72b, a transom top panel 74a and a transom bottom panel 74b, as shown in FIG. 10. Additional elements, for example, such as one or more window elements, may be incorporated in the present invention. The one or more window elements may be of any shape or size, such as a half-moon shape shown in FIG. 6. The one or more window elements may incorporate one or more window frames. Such window frames may be formed of components 76 and 78 as shown in FIG. 11, and 80 and 82 as shown in FIG. 12.

To assemble the components of the present invention, a variety of attachment means may be utilized, such as screws. Attachment of the components by way of attachment means may be positioned at a variety of points in the door system, such as at the corner points.

The sidelites may be assembled first. Weather-stripping may be inserted into the sidelites to facilitate a seal between the door and the sidelites. The sidelites may also be corrugated, for example, such as with one inch corrugated fasteners to inside and outside.

A transom box may be assembled, in a manner shown in FIG. 6, by a variety of attachment means, such as nails, screws, staples, or other attachment means. The corners may be mitered and/or welded in the process of assembly, as appropriate for an embodiment of the present invention. The transom box may be attached to the top of the sidelites assembly by any attachment means, for example, such as one or more coarse thread fasteners.

One or more window frames may be assembled, by a variety of attachment means, such as nails, screws, staples, or other attachment means. The corners may be mitered and/or welded in the process of assembly, as appropriate for an embodiment of the present invention. The window boxes may be attached to the top as a transom box. The window frames may be attached by any attachment means, for example, such as screws, staples, or any other attachment means.

The brickmold may be attached to the assembled sidelites at the side and the above the transom box. If window frames are included in the door system, then the brickmold may be positioned above the window frames. The result may be that the sidelites, transom box and any window frames are positioned within the brickmold, so that the brickmold surrounds the sidelites, transom box and any window frames. Such attachment may be facilitated by either staples or screws. The brickmold may be back-beaded with a sealant, for example, such as Mulco™.

The hinges and locks may be installed on sidelites and the doors, in accordance with any machined areas in the sidelites and/or doors created to facilitate the attachment of hardware thereto. The doors may be attached to the sidelites by way of the hardware or by other means. Mull covers may be sealed and attached to one or more of the sidelites. The attachment may be facilitated by a variety of attachment means, for example, such as pin-nails.

In the manner described previously, the components of the present invention may be stained, painted, or otherwise coloured or coated. Staining, painting, colouring or coating may occur prior to assembly of the present invention, after assembly, or at stages prior to and after assembly. Any staining, painting, colouring or coating may occur onsite where the door system or window system may be installed. The chosen stain, paint, colour or coating may match or complimentarily contrast with other components of the present invention and/or nearby objects.

It will be appreciated by those skilled in the art that other variations of the embodiments described herein may also be practiced without departing from the scope of the invention. Other modifications are therefore possible.

I claim:

1. A stainable vinyl door system for in situ installation comprising:
(a) a wood substrate, and
(b) a vinyl covering system adapted to accept a stain colour matching system, the vinyl covering system having a top layer with a printed wood grain pattern and a bottom layer adapted to adhere to the wood substrate,
wherein the stain colour matching system is applied to the top layer of the vinyl covering system after the installation of the door system.

2. A stainable vinyl door system as claimed in claim 1 wherein the bottom layer of the vinyl covering system is 80 to 120 μm thick.

3. A stainable vinyl door system as claimed in claim 2 wherein the top layer of the vinyl covering system is 30 to 70 μm thick.

4. A stainable vinyl door system as claimed in claim 1 wherein the top layer of the vinyl covering system includes a wood grain textured profile.

5. A stainable vinyl door system as claimed in claim 1 wherein the stain colour matching system further comprises a desired stain colour applied to the stainable vinyl door system once the stainable vinyl door system is in situ.

6. A stainable vinyl door system as claimed in claim 5 wherein the stain colour matching system further comprises a transparent protective layer applied on top of the desired stain colour.

7. A stainable vinyl door system as claimed in claim 6 wherein the transparent protective layer is urethane.

8. A stainable vinyl door system for installation into an environment comprising:
(a) a wood substrate, and
(b) a vinyl covering system adapted to accept a stain colour matching system, the vinyl covering system having a top layer with a printed wood grain pattern and a bottom layer adapted to adhere to the wood substrate,
wherein the stain colour matching system matches the stainable vinyl door system identically to the environment.

9. A stainable vinyl window system for in situ installation comprising:
(a) a wood substrate,
(b) a vinyl covering system adapted to accept a stain colour matching system, the vinyl covering system having a top layer with a printed wood grain pattern and a bottom layer adapted to adhere to the wood substrate,
wherein the stain colour matching system is applied to the top layer of the vinyl covering system after the installation of the window system.

10. A stainable vinyl window system as claimed in claim 9 wherein the bottom layer of the vinyl covering system is 80 to 120 μm thick.

11. A stainable vinyl window system as claimed in claim 10 wherein the top layer of the vinyl covering system is 30 to 70 μm thick.

12. A stainable vinyl window system as claimed in claim 9 wherein the top layer of the vinyl covering system includes a wood grain textured profile.

13. A stainable vinyl, window system as claimed in claim 9 wherein the stain colour matching system further comprises a desired stain colour applied to the stainable vinyl window system once the stainable vinyl window system is in situ.

14. A stainable vinyl window system as claimed in claim 13 wherein the stain colour matching system further comprises a transparent protective layer applied on top of the desired stain colour.

15. A stainable vinyl door system as claimed in claim 15 wherein the transparent protective layer is urethane.

16. A method of assembling a stainable vinyl door system comprising:
(a) covering a wood or PVC substrate with a vinyl covering system adapted to accept a stain colour matching system,
(b) adhering a bottom layer of the vinyl covering system to the wood substrate,
(c) adhering a top layer of the vinyl covering system with a printed wood grain pattern to the bottom layer,
(d) installing the stainable vinyl door system, and
(e) applying the stain colour matching system to the top layer of the vinyl covering system after the installation of the door system.

17. A method of assembling a stainable vinyl door system as claimed in claim 16 further comprising applying a desired stain colour of the stain colour matching system to the top layer with a printed wood grain pattern.

18. A method of assembling a stainable vinyl door system as claimed in claim 17 further comprising applying a transparent protective layer applied on top of the desired stain colour.

19. A method of assembling a stainable vinyl door system for installation into an environment comprising:
(a) covering a wood or PVC substrate with a vinyl covering system adapted to accept a stain colour matching system,
(b) adhering a bottom layer of the vinyl covering system to the wood substrate,
(c) adhering a top layer of the vinyl covering system with a printed wood grain pattern to the bottom layer,
(d) applying a stain colour matching system to the top layer of the vinyl covering system wherein the stain colour matching system matches the stainable vinyl door system identically to the environment with the stain colour.

20. A method of assembling a stainable vinyl door system as claimed in claim 19 further comprising applying a desired stain colour of the stain colour matching system to the top layer with a printed wood grain pattern.
